(19) United States
(12) Patent Application Publication
(10) Pub. No.: US 2007/0029395 A1
(43) Pub. Date: Feb. 8, 2007

(54) Thermostatic mixing valve

(75) Inventor: Tony Mark Scott, Bunya (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: GSA Industries (Aust.) Pty. Ltd., Melbourne (AU)

(21) Appl. No.: 11/486,607

(22) Filed: Jul. 14, 2006

(30) Foreign Application Priority Data
Jul. 19, 2005 (AU) 2005903830

(51) Int. Cl. G05D 23/13

(52) U.S. Cl. 236/12.2

(57) ABSTRACT

A thermostatic mixing valve 10 including a valve body 11 having a first fluid 12 inlet, a second fluid inlet 13 and a mixed fluid outlet 14, a mixing chamber 16 located between the respective fluid inlets 12,13 and the fluid outlet 14. A thermostatic element 15 is located for exposure to mixed fluid and a piston 17 is arranged for movement within the valve body in response to expansion or contraction of the thermostatic element 15. The piston 17 throttles flow of fluid through the first fluid inlet 12 into the mixing chamber 16 by varying its position relative to a first seat 33, and through the second fluid inlet 13 into the mixing chamber 16 by varying its position relative to a second seat formed as a bore 35 into which the piston 17 can progressively enter. Progression of the piston 17 into the bore 35 initially results in a substantial throttling of the flow of fluid from the second fluid inlet 13 into the mixing chamber 16, while further progression results in engagement between the piston 17 and the second seat 35 to terminate the flow of fluid from the second fluid inlet 13 into the mixing chamber 16.

### FIELD OF THE INVENTION

The present invention relates to a thermostatic mixing valve.

### BACKGROUND OF THE INVENTION

Thermostatic mixing valves enable hot and cold fluids, typically water, to be accurately mixed so as to deliver fluid at a desired temperature to the valve outlet. Thermostatic mixing valves typically include separate inlets for ingress of hot and cold water and one outlet for egress of mixed water.

Some thermostatic mixing valves include seats for cooperating with a piston for respectively throttling or isolating the flow of hot and cold fluids through the valve. The need for isolation typically is for safety reasons and it normally is most important to provide for isolation of the hot fluid, so that, for example, a person showering is protected from scalding in the event of the failure of the cold water supply. In such valves, a hard edge of the piston can press firmly against a flat face of the valve body to thereby prevent fluid flow therepast. This arrangement can be provided for one or each of the hot and cold inlets.

The design of mixing valves of the kind described above has been complicated by the need to provide a mechanism for allowing for any continued expansion of the thermostatic element after an adjustment in the flow of hot and cold fluids. If the thermostatic element cannot continue to expand when the piston has no further available movement, i.e. the piston is pressed firmly into engagement with one of the flat faces, then the thermostatic element can be damaged. This problem has been addressed in one arrangement by including a spring to permit continued movement of the thermostatic element against the spring, such that the spring compresses as the thermostatic element expands. Unfortunately, the inclusion of such an arrangement has increased the part and production costs for the valve.

The design of thermostatic mixing valves has been further complicated by the requirements for adequate responsiveness to changes in inlet temperatures and pressures, to maintain a set outlet temperature and to also provide for complete termination of the flow of hot water through the valve when necessary. Mixing valves of the kind described above, which include a piston arranged for cooperation with one or two flat face seats, can provide a high degree of responsiveness, but under some circumstances the piston can oscillate undesirably. Also, while some mixing valves can substantially reduce fluid flow, not all such valves can provide complete termination of flow.

The above discussion is included in this specification solely for the purpose of providing a context for the present invention. It is not suggested or represented that any of these matters formed part of the prior art base or were common general knowledge in the field relevant to the present invention as it existed before the priority date of each claim of this application.

It is an object of the present invention to overcome or at least alleviate one or more of the foregoing problems.

### SUMMARY OF THE INVENTION

According to the present invention there is provided a thermostatic mixing valve including a valve body having a first fluid inlet, a second fluid inlet and a mixed fluid outlet, a mixing chamber located between the respective fluid inlets and the fluid outlet, a thermostatic element located in or adjacent to the mixing chamber for exposure to mixed fluid, a piston arranged for movement within the valve body in response to expansion or contraction of the thermostatic element, the piston being arranged to throttle flow of fluid through the first fluid inlet into the mixing chamber by varying its position relative to a first seat, the piston also being arranged to throttle flow of fluid through the second fluid inlet into the mixing chamber by varying its position relative to a second seat, and wherein the second seat includes a bore into which the piston can progressively enter, progression of the piston into the bore initially results in a substantial throttling of the flow of fluid from the second fluid inlet into the mixing chamber, while further progression results in engagement between the piston and the second seat to terminate the flow of fluid from the second fluid inlet into the mixing chamber.

A mixing valve according to the present invention advantageously provides an arrangement in which a substantial throttling of the flow of fluid from the second fluid inlet into the mixing chamber occurs prior to complete termination of that flow of liquid. This can be compared to earlier arrangements in which the hard edge of the piston of a valve engages against a flat face of the valve body to terminate fluid flow. As discussed above, such a valve has a responsiveness to changes in temperature and/or pressure that can be too great in certain extreme conditions and which can result in the piston oscillating uncontrollably. In a valve according to an embodiment of the invention, the responsiveness can be moderated by the entrance of the piston to within the bore to provide a substantial throttling effect, prior to actual termination of the fluid flow. Testing has shown that the moderated response still satisfies commercial requirements for responsiveness, but with the benefit of complete reduction, or at least a major reduction, in the propensity for the piston to oscillate undesirably.

The extent of throttling of the fluid flow through the second fluid inlet is in part a function of the dimensions of the bore relative to the piston. That is, the closeness of the fit between the piston and the bore has an effect on the extent to which fluid flow from the second fluid inlet into the mixing chamber is throttled when the bore enters the piston. Put simply, the closer the fit, the greater the fluid flow is throttled. As an example, in one arrangement, the bore has an internal diameter of 27.1 mm while the piston has an external diameter of 27.0 mm. In this arrangement, a normal flow from the second fluid inlet can be throttled to a trickle or a slight leak.

While entry of the piston into the bore provides a substantial throttling effect, it does not fully terminate fluid flow from the second fluid inlet into the mixing chamber. Rather, hot fluid can still flow into the mixing chamber, but at a significantly reduced rate. Permitting a continued flow of this kind is sometimes desirable, so that the thermostatic element is maintained exposed to hot fluid and therefore is kept from cooling and contracting, and thereby possibly withdrawing the piston from the second seat. However it is also desirable in certain circumstances that flow of hot fluid from the second fluid inlet be terminated completely, so that there is no flow at all into the mixing chamber. This safeguards against the possibility for example, of a person being exposed even to a very low flow of hot fluid when the cold fluid supply has failed.

Engagement between the piston and the second seat can be achieved in any suitable manner. In the preferred arrangement, radial engagement occurs, such as by an annular seal extending about the outer surface of the piston and being arranged to sealingly engage against the internal wall of the bore when progression of the piston has caused it to enter the bore sufficiently. The position of the seal relative to the piston has an effect on when termination of flow of fluid from the second fluid inlet into the mixing chamber occurs. For example, the seal could be positioned close to the leading end of the piston relative to the bore, so that termination of flow occurs almost immediately when the piston enters the bore. Alternatively, the seal can be positioned rearwardly away from the leading end, so that there is a greater delay between the substantial throttling of fluid flow that occurs upon entry of the piston within the bore and the termination of that flow.

The seal can take any suitable form but most likely will be an O-ring seal. To locate the seal, an annular groove can be provided in the outer surface of the piston.

In an alternative arrangement, engagement between the piston and the second seat can be axial engagement, such as by engagement of the leading end of the piston with a facing surface of the second seat. The facing surface might be formed as a step in the bore. A resilient seal may be fixed to one of the facing surface or the piston end. As an alternative to the piston end engaging the facing surface, the piston may have a step formed in its outer surface or it may have a flange that projects from the outer surface. In either case, engagement can be provided with the facing surface of the bore, which could take the form discussed above, or which could take other forms, such as the portion of the valve which surrounds the open end of the bore.

A further advantage of the present invention is that in one form entry of the piston into the bore can allow for continued expansion of the thermostatic element, despite the piston being in engagement with the second seat. In the embodiment above in which the annular seal is disposed about the piston, engagement between the piston and the second seat can be maintained despite the thermostatic element continuing to expand and thus continuing to move the piston further into the bore.

In other forms of the invention, which embody axial engagement, a spring arrangement can be provided, against which the thermostatic element can expand.

The first fluid seat is preferably formed as a flat face against which an end of the piston engages.

An adjustment mechanism may be provided to adjust the set temperature of the fluid which passes through the mixed fluid outlet. Preferably, adjustment by the adjustment mechanism results in a change in the proportions of fluid from the respective hot and cold fluid inlets into the mixing chamber so that the set temperature of the fluid flowing through the mixed fluid outlet is adjusted.

In the preferred forms of the invention, a check valve is mounted adjacent each of the hot and cold fluid inlets to prevent back flow of fluid through the respective inlets.

### BRIEF DESCRIPTION OF THE DRAWINGS

Embodiments of the invention will now be described, by way of example only, with reference to the accompanying drawings in which:

FIG. 1 is a cross sectional view of a thermostatic mixing valve in accordance with an embodiment of the invention.

FIG. 2 is a detailed view of the circled section of FIG. 1.

### DETAILED DESCRIPTION OF THE PREFERRED EMBODIMENTS

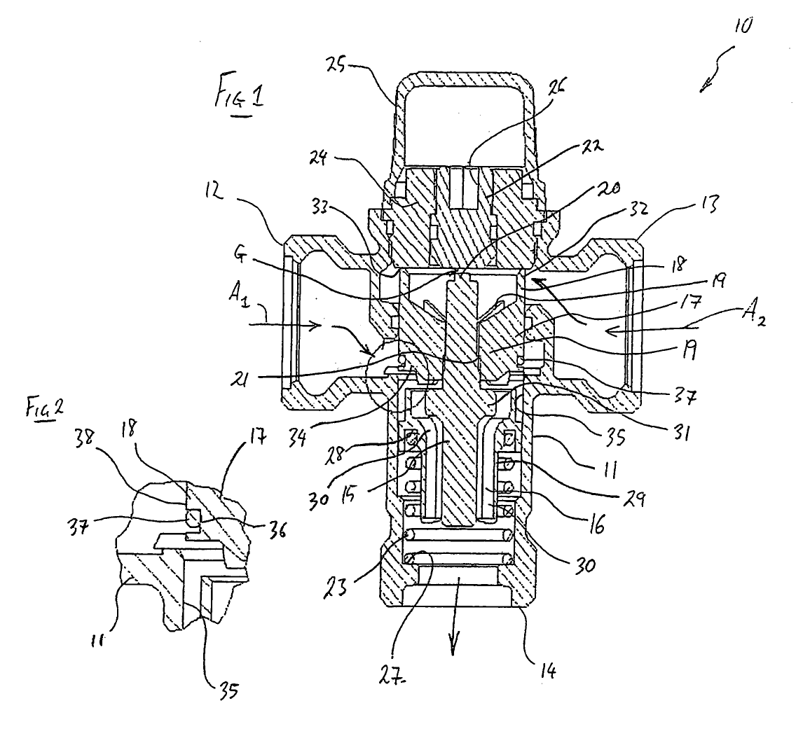

FIG. 1 illustrates in cross-section, a thermostatic mixing valve 10 in accordance with an embodiment of the invention. The valve 10 includes a valve body 11, a hot fluid inlet 12, a cold fluid inlet 13 and a mixed fluid outlet 14. Each of the inlets 12 and 13 and the outlet 14 are arranged for connection to suitable piping.

Disposed within the valve body 11 is a thermostatic element 15. The thermostatic element 15 is disposed within a mixing chamber 16 and disposed about an upper end of the element 15 is a regulating piston 17. The piston 17 comprises a cylindrical member 18 and webs 19 which depend from the cylindrical member 18 and which extend to the element 15. In use, fluid can flow into the interior of the cylindrical member 18 for passage through the mixed fluid outlet 14, and the webs 19 provide minimal resistance to that flow. The webs 19 are threadably connected to the element 15 and abut against a step 21 formed on the element 15. In an alternative arrangement, the threaded connection can be omitted and a biasing arrangement provided to maintain the element 15 and the piston 17 together. In that alternative arrangement the step 21 can be provided as an abutment against which the piston 17 is biased. The cooperation is such that the piston 17 is constrained to move with the element 15 when the element 15 moves in an upward direction toward the adjustment element 22.

A plunger 20 of the element 15 is mounted for contact with an adjustment element 22. The adjustment element 22 is a threaded element, which can be rotated so as to alter the gap G between the element 22 and the plunger 20. Alteration of the size of the gap G is the manner by which the set temperature of the mixed fluid which passes through the outlet 14 can be set. The adjustment element 22 is threadably mounted within a fixed element 24, while a removable cover 25 extends over both of the elements 22 and 24. The element 22 includes a recess 26 shaped for receipt of an Allen key or equivalent tool for rotating the element 22.

A spring 23 is seated against a step 27 formed in the valve body 11 at one end and at the other end within a recess 28 of a mixing tube 29. The mixing tube 29 and the thermostatic element 15 are in contact, such that the element 15 rests against the mixing tube 29. The mixing tube 29 includes radially inwardly extending webs 30, while the element 15 includes a broadened section 31, which is of greater diameter than the sections which extend upwardly and downwardly from it. It is the broadened section 31 which rests upon and is supported by upper edges of the webs 30. The spring 23 is operable to urge the mixing tube 29 toward the adjustment element 22, and by the resting connection between the tube 29 and the element 15, the element 15 is also urged in that direction.

The arrows A₁, A₂ show the path of fluid entering each of the inlets 12 and 13. In the illustrated orientation of the valve 10, fluid following the path of arrow A₁ enters the inlet 12 and flows downwardly, while fluid which enters the inlet 13 and follows the path A₂ flows upwardly. Referring first to the path of fluid that follows the arrow A₂, that fluid is directed towards the upper end 32 of the piston 17 and that end 32 is movable toward and away from a first seat 33 formed by a flat face of the fixed element 24. In FIG. 1, the position of the piston 17 is such that the end 32 is in contact with the first seat 33. In that position, no fluid will flow past the seat 33. When the piston 17 moves away from the first seat 33, fluid flow through the inlet 13 along the path of arrow A₂ and into the mixing chamber 16 can commence.

The position of the piston 17 in FIG. 1, is the position it is urged to indirectly by the spring 23 when there is no flow of hot fluid through the inlet 12. Upon flow being initiated, hot fluid flows along the path of arrow A₁ and into the mixing chamber 16. The thermostatic element 15 reacts to the temperature of the hot fluid and expands, causing the plunger 20 to take up the gap G. When the plunger 20 engages the adjustment element 22, further expansion of the element 22 causes the element to move in a direction towards the outlet 14, against the bias of the spring 23. That movement permits the piston 17 to move in the same direction, releasing the piston end 32 from the seat 33 and permitting flow of cold fluid past the seat 33 and into the mixing chamber 16. Expansion of the element 15 will cease, when the mixed fluid set temperature of the valve 10 has been reached.

The thermostatic element 15 is operable normally to shift the piston 17 in small amounts to compensate for slight variations in the supply temperatures and/or pressures of the hot or cold fluid supplies and thereby to maintain the set mixed outlet temperature. The thermostatic element 15 is operable to make larger shifts in the position of the piston 17, generally in circumstances where a major disruption or an actual failure of either the hot or cold fluid supply has occurred, particularly the cold fluid supply. In such circumstances the piston 17 may be shifted to a position to substantially throttle or to terminate the flow of the fluid for which the supply has not failed.

Referring now to the path of fluid that follows the path of the arrow A₁, that fluid flows towards a lower end 34 of the piston 17. Referring to FIG. 2, the cylindrical member 18 of the piston 17 has an outer diameter which is slightly smaller than the inner diameter of the bore 35 formed in the valve body 11. Thus, the piston 17 can move into the bore 35 if there is sufficient movement of the piston 17 away from the first seat 33. As discussed earlier, the difference in diameter can be about 0.1 mm. The bore 35 forms a second seat which cooperates with the piston 17 to throttle the flow of fluid from the inlet 12 into the mixing chamber 16. It will be appreciated, that as the piston 17 moves away from the first seat 33 and approaches entry into the bore 35, the available space for flow of fluid through the inlet 12 and into the mixing chamber 16 reduces. When the piston 17 actually enters the bore 35, a substantial throttling of the flow of fluid through the inlet 12 occurs. However, complete termination of fluid flow through the inlet 12 is not achieved, because there is a slight gap between the outside of the cylindrical member 18 and the bore 35. Thus, fluid following the path A₁ can still leak or trickle past the piston 17.

For complete termination of flow through the inlet 12, the piston 17 includes an annular groove 36 which seats an O-ring 37. The outer diameter of the O-ring 37 extends radially slightly beyond the outer surface 38 of the cylindrical member 18 and in the embodiment shown, when the piston 17 enters the bore 35 a sufficient distance, the O-ring 37 engages and seals against the inner surface of the bore 35, providing complete termination of fluid flow from the inlet 12 and into the mixing chamber 16. Typically, this will occur when there has been a failure in the supply of cold fluid, so that only hot fluid is flowing into the mixing chamber 16.

It will be readily seen, that the above arrangement can provide for substantial throttling of fluid flow from each of the inlets 12 and 13 into the mixing chamber 16, and for complete termination of flow into the mixing chamber 16. In respect of the inlet 12, the substantial throttling that occurs prior to complete termination of fluid flow, advantageously moderates the responsiveness of the valve 10 when compared to prior art arrangements which employ the throttling arrangement described above in relation to the inlet 13, also for the inlet 12. By moderating the throttling effect, undesirable piston oscillation can be eliminated or minimised.

The arrangement described above for the inlet 12 could also be provided for the inlet 13, although this is not considered necessary when the mixing valve 10 is employed for mixing hot and cold water, for delivery to showers and basins etc. In that use, it is usually only necessary for safety purposes, to throttle or terminate flow of hot water when the supply of cold water fails, to prevent scalding.

The invention described herein is susceptible to variations, modifications and/or additions other than those specifically described and it is to be understood that the invention includes all such variations, modifications and/or additions which fall within the spirit and scope of the above description.

The claims defining the invention are as follows:

1. A thermostatic mixing valve including a valve body having a first fluid inlet, a second fluid inlet and a mixed fluid outlet, a mixing chamber located between the respective fluid inlets and the fluid outlet, a thermostatic element located in or adjacent to the mixing chamber for exposure to mixed fluid, a piston arranged for movement within the valve body in response to expansion or contraction of the thermostatic element, the piston being arranged to throttle flow of fluid through the first fluid inlet into the mixing chamber by varying its position relative to a first seat, the piston also being arranged to throttle flow of fluid through the second fluid inlet into the mixing chamber by varying its position relative to a second seat, and wherein the second seat includes a bore into which the piston can progressively enter, progression of the piston into the bore initially results in a substantial throttling of the flow of fluid from the second fluid inlet into the mixing chamber, while further progression results in engagement between the piston and the second seat to terminate the flow of fluid from the second fluid inlet into the mixing chamber.

2. A thermostatic mixing valve according to claim 1, wherein the engagement between the piston and the second seat occurs radially between a radially outer surface of the piston and a facing inner surface of the bore.

3. A thermostatic mixing valve according to claim 2, wherein the engagement occurs between an annular seal which extends circumferentially about the piston and the inner surface of the bore.

4. A thermostatic mixing valve according to claim 3, wherein the annular seal is an O-ring.

5. A thermostatic mixing valve according to claim 1, wherein the engagement between the piston and the second seat occurs axially between axially opposed faces respectively of the piston and the bore.

6. A thermostatic mixing valve according to claim 5, wherein the opposed faces comprise a surface of a step in the bore and an end face of the piston.

7. A thermostatic mixing valve according to claim 5, wherein the opposed faces comprise a surface of steps formed in each of the bore and the piston.

8. A thermostatic mixing valve according to claim 5, wherein the opposed faces comprise a surface of a step formed in the piston and a surface which surrounds the open end of the bore.

9. A thermostatic mixing valve according to claim 5, wherein a seal is disposed in one of the opposed faces.
